(19) United States
(12) Patent Application Publication
(10) Pub. No.: US 2003/0142425 A1
(43) Pub. Date: Jul. 31, 2003

(54) Wide vision rearview mirror with adjustable mounts

(76) Inventor: Jose Bustos, Scarborough (CA)

Correspondence Address: BERESKIN AND PARR, SCOTIA PLAZA, 40 KING STREET WEST-SUITE 4000 BOX 401, TORONTO, ON, M5H 3Y2, CA

(21) Appl. No.: 10/059,164

(22) Filed: Jan. 31, 2002

(51) Int. Cl. G02B 7/182

(52) U.S. Cl. 359/872; 359/881; 248/479

(57) ABSTRACT

A wide vision rearview mirror apparatus includes a generally rectangular planar mirror mounted within an elongated mirror housing extending along a longitudinal axis substantially across the windshield of the vehicle, and a pair of spaced adjustable mounts extending from the back portion of the housing for mounting the housing to the windshield. The planar mirror preferably extends at an angle to the longitudinal axis. Each mount comprises a telescopic main body extending generally perpendicular to the housing, and joint mechanisms extending from either end. The joint mechanisms can provide a wide range of adjustments which enable the mirror and housing to be adjusted to suit a wide variety of drivers.

### FIELD OF THE INVENTION

This invention relates to rearview mirrors for vehicles, and in particular, to interior wide vision rearview mirrors with adjustable mounts.

### BACKGROUND OF THE INVENTION

For driving comfort and safety reasons, it is essential for drivers to continuously monitor the road behind them while maintaining their attention on the traffic in front of their vehicles. Before changing lanes or turning corners, careful drivers tend to check both the central and side rearview mirrors and then to turn their head to ensure that there are no vehicles within the so-called blind spot. However, the time lapse during this shift of visual and mental attention from the traffic in front of the vehicle can sometimes create a hazardous condition.

This concern is addressed to some extent by “wide-angled” rearview mirrors, consisting of a composite of several fixed angled reflective surfaces, which provide a panoramic field of view wider than that of a conventional rearview mirror. However, these wide-angled mirrors produce confusing discontinuities as the driver's view shifts from one reflective surface to another. While other prior art mirrors, consisting of a concave or convex reflective surface, avoid these discontinuities, they produce substantial distortion of the reflected objects.

Since wide-angled mirrors are not original equipment on most new vehicles, it is generally necessary to retrofit these mirrors onto a vehicle. Some aftermarket wide-angle mirrors use attachment systems which fasten the mirror directly to the sides of the vehicle or the upper header which forms part of the roof structure of the vehicle. These attachment systems tend to be unsightly and they can sometimes produce a less than solid mount. Other attachment systems utilize mounts for adhesively attaching the mirror to the interior surface of the windshield, but these mounts provide limited adjustment about horizontal and vertical axes and are sometimes incapable of supporting the weight of the wide-angled mirror.

Accordingly, there is a need for a rearview mirror which enables the driver to observe an undistorted, wide angle view of the traffic conditions to the rear of the vehicle. There is also a need for a rearview mirror which minimizes the need for the driver to unnecessarily shift his eyes or turn his head to obtain a full rearview of the roadway. There is a further need for a rearview mirror having mounts which are easy to install and are sufficiently adjustable so as to provide a variety of drivers with a wide field of view.

### SUMMARY OF THE INVENTION

The subject invention is directed to a rearview mirror apparatus for mounting to a front windshield of a vehicle. The mirror apparatus comprises an elongated mirror housing shaped to extend along a longitudinal axis substantially across a top, inside portion of the windshield. The housing has an elongated front opening and a planar mirror is mounted within the opening of the housing. The mirror is disposed in a plane extending at an angle to the longitudinal axis of the housing. A pair of spaced mounts extend from the back portion of the housing for mounting the housing to the windshield.

The housing is shaped generally in the form of a wedge having a thin edge and a thick edge. The housing comprises a back wall extending in a first plane parallel to the longitudinal axis, a top portion, and a bottom portion, the top and bottom portions having front edges which together define a generally rectangular front surface extending in a second plane offset at an angle to the first plane. The front surface defines a generally rectangular opening shaped for receiving the mirror and preferably comprises a lip portion shaped for retaining the mirror within the housing.

The subject invention is also directed to a rearview mirror apparatus comprising an elongated mirror housing extending along a longitudinal axis, a planar mirror mounted within the housing, and a pair of spaced mounts extending from a back portion of the housing for mounting the housing to the windshield, wherein each mount comprises an adjustable mount having a telescopic main body extending generally perpendicular to the housing and the windshield.

The subject invention is further directed to an adjustable mount for mounting a housing for a rearview mirror to an inside portion of a windshield of a vehicle, comprising a telescopic main body extending generally perpendicular to the housing and the windshield. The telescope main body comprises a cylinder having a closed end adjacent to the housing and an open end adjacent to the windshield, a shaft shaped to slidingly fit within the cylinder through the open end, and securing means for adjustably securing the shaft in a set position relative to the cylinder. The securing means preferably comprises a set screw within a threaded aperture which secures the cylinder against a keyed surface on the shaft thereby preventing the shaft from moving relative to the cylinder.

Each of the adjustable mounts include a first joint mechanism extending from the closed end of the cylinder for connecting the cylinder to the housing, and a second joint mechanism extending from the shaft for rotatably connecting the shaft to the windshield. The first joint mechanism preferably includes an annular flange having a central aperture, a U-shaped bracket extending perpendicularly to the housing having spaced side portions with apertures, and a fastener which is shaped to fit through the apertures in the side portions of the U-shaped bracket and the aperture in the annular flange to releasably fasten the annular flange to the U-shaped bracket. The second joint mechanism preferably includes a ball-and-socket joint having a ball extending from the end of the shaft and a socket portion attachable to the windshield.

### BRIEF DESCRIPTION OF THE DRAWINGS

For a better understanding of the present invention, and to show more clearly how it may be carried out in practice, reference will now be made, by way of example only, to the accompanying drawings, in which:

FIG. 1 is a perspective view of a mirror apparatus made in accordance with a preferred embodiment of the invention, shown mounted in a vehicle;

FIG. 2 is a front perspective view of the subject mirror apparatus;

FIG. 3 is a rear perspective view of the subject mirror apparatus showing a pair of spaced mounts;

FIG. 4 is a top plan view of the mirror apparatus showing the pair of spaced mounts and the wedge-like shape of the mirror apparatus;

FIG. 5A is a front elevation view of the subject mirror apparatus;

FIG. 5B is a rear elevation view of the subject mirror apparatus showing the pair of spaced mounts;

FIG. 6 a sectional plan view of a portion of the subject mirror apparatus shown in FIG. 4, showing a lip portion shaped for retaining the mirror within the housing;

FIG. 7 is a side view of the thick edge of the subject mirror apparatus along the pivotal axis of the first joint mechanism;

FIG. 8 is a side view of the thin edge of the subject mirror apparatus along the pivotal axis of the first joint mechanism; and

FIG. 9 is an exploded view of the components of the mount in accordance with a preferred embodiment of the present invention.

### DETAILED DESCRIPTION OF THE INVENTION

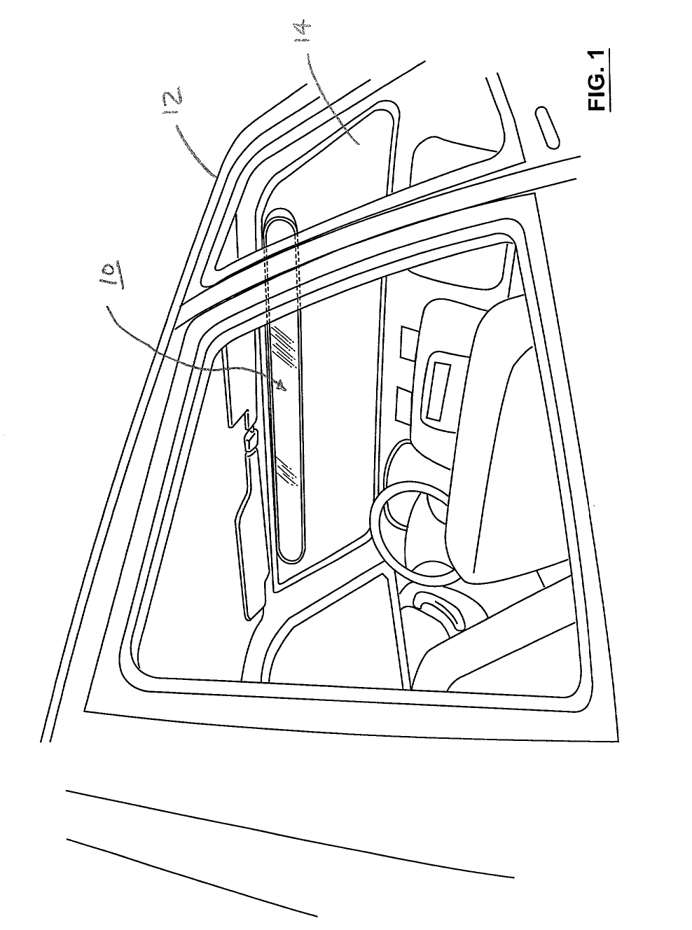

Reference is made to FIGS. 1-3 which illustrate a mirror apparatus 10 made in accordance with a preferred embodiment of the invention. Mirror apparatus 10 is mounted inside a vehicle 12 along the top of a front windshield 14. Mirror apparatus 10 comprises an elongated mirror housing 16, a generally planar mirror 18 extending substantially across the windshield 14, and a pair of spaced adjustable mounts 42.

Mirror 18 extends substantially across the windshield, in the sense that housing 16 is sized to extend across most of a top portion of windshield 18, leaving about 1-5 inches of clearance on either side. The length of housing 16 preferably ranges from about 38 inches for a mirror suitable for use in smaller cars to about 48 inches for a mirror suitable for use in large cars and light trucks. Mirror 18 is preferably generally rectangular in shape, with rounded corner portions 20.

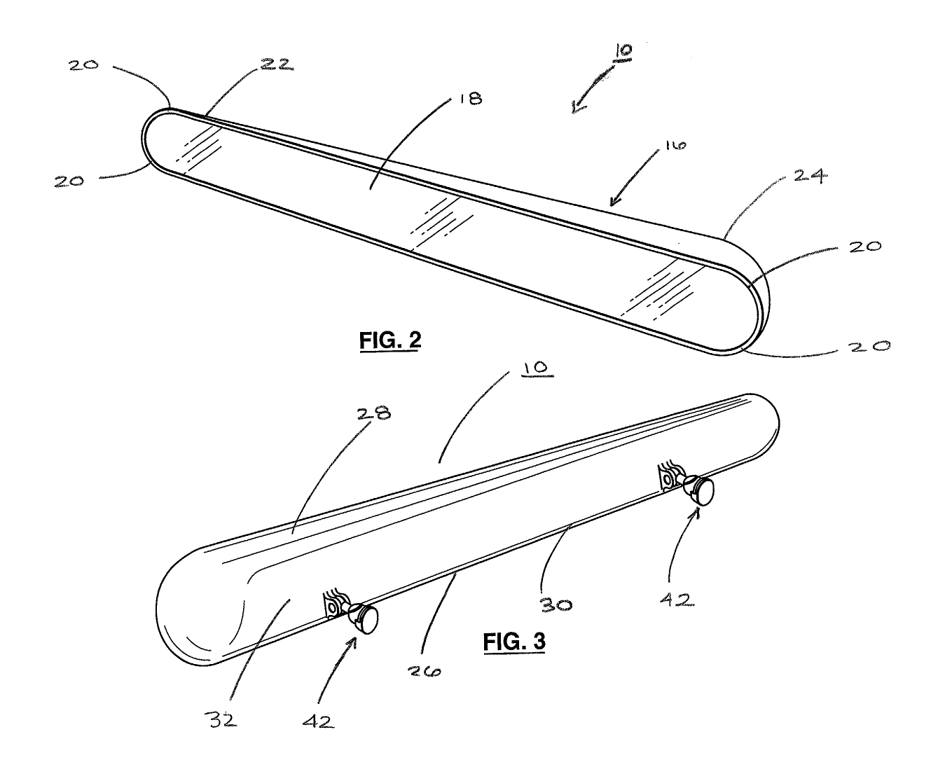

Referring to FIGS. 2, 3 and 4, mirror housing 16 is shaped generally in the form of a wedge having a thin edge 22 and a thick edge 24, where thin edge 22 is positioned adjacent to the driver's side of vehicle 12. Mirror housing 16 has a back wall 26 extending in a first plane parallel to the longitudinal axis A-A, a top portion 28 and a bottom portion 30. Back wall 26 includes a back portion 32 from which extend mounts 42. Mounts 42 have a telescopic main body 44 extending generally perpendicular to the housing 16 and windshield 14.

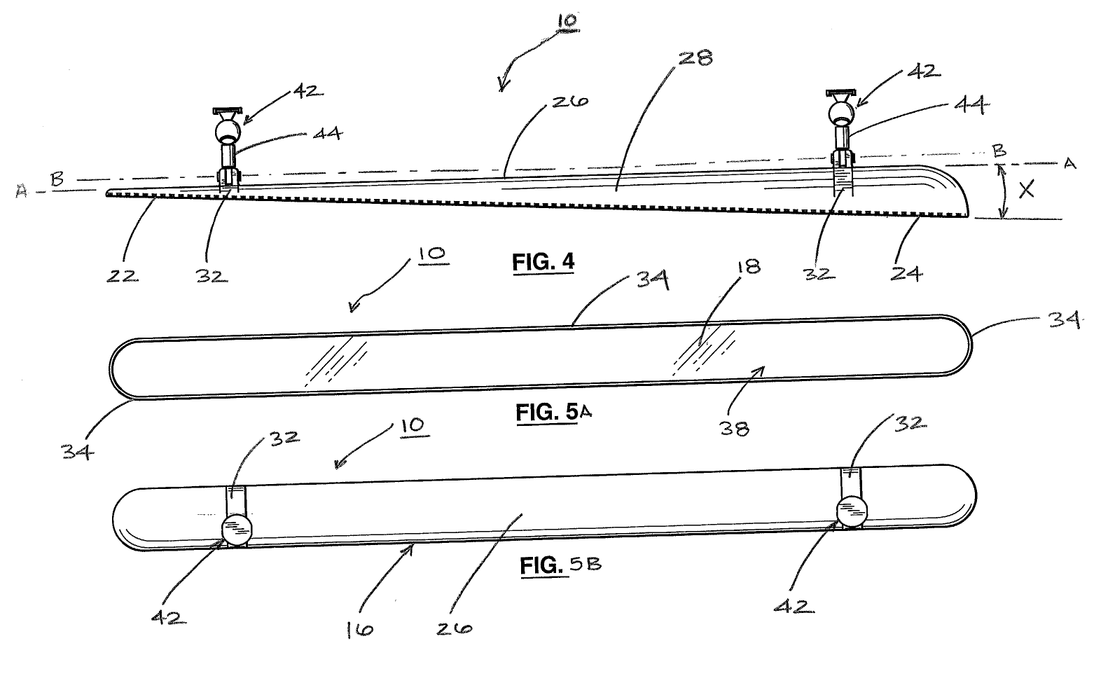

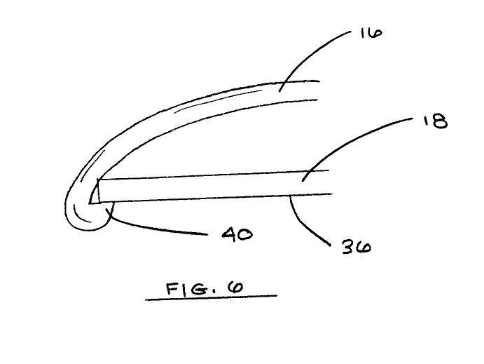

Referring to FIGS. 4, 5A and 5B, top portion 28 and bottom portion 30 of housing 16 have front edges 34 which together define a generally rectangular front surface 36 extending in a second plane offset at an angle x to the first plane. Front surface 36 has a generally rectangular front opening 38 which receives mirror 18. Mirror 18 extends substantially across the full length of housing 16 at an angle x to the longitudinal axis A-A of housing 16. As best shown in FIG. 6, the front surface 36 has a lip portion 40 shaped for retaining mirror 18 within housing 16 by mechanical entrapment.

Mirror housing 16 can be formed of any suitable material, as for example, plastics and reinforced plastics formed by suitable molding techniques, metal materials and other structural materials. Mirror 18 can be formed of any suitable reflective material, typically a glass plate with a metalized surface on the rear portion thereof.

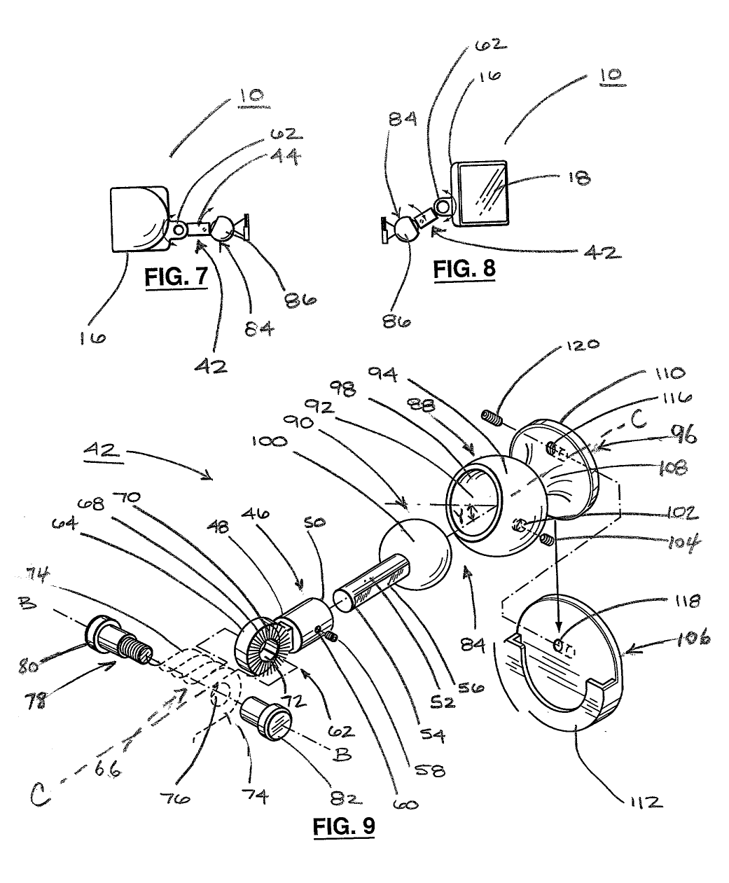

Referring to FIGS. 7, 8 and 9, telescopic main body 44 of adjustable mounts 42 comprises a cylinder 46 having a closed end 48 adjacent to mirror housing 16 and an open end 50 adjacent to windshield 14. The open end 50 receives a shaft 52 shaped to slidingly fit within the cylinder 46. Securing means 54 adjustably secures shaft 52 in a set position relative to cylinder 46. Securing means 54 comprises a keyed surface 56 on shaft 52, a first set screw 58 and a first threaded aperture 60 in the side of cylinder 46. First set screw 58 may be releasably tightened in first threaded aperture 60 against keyed surface 56 to prevent telescopic body 44 from moving relative to windshield 14 during the operation of vehicle 12.

Adjustable mounts 42 further comprise a first joint mechanism 62 and a second joint mechanism 80. First joint mechanism 62 extends from the closed end 48 of cylinder 46 for pivotally connecting cylinder 46 to mirror housing 16. First joint mechanism 62 enables the pivotal movement of mirror housing 16 about a pivot axis B-B parallel to and spaced from the longitudinal axis A-A of housing 16 (see FIG. 4). First joint mechanism 62 includes an annular flange 64 extending from the first end of the cylinder 46, and a U-shaped bracket 66 extending from the back of housing 16. The annular flange 64 includes a pair of flat opposed side surfaces 68 which have a serrated surface 70 and a first aperture 72.

U-shaped bracket 66, shown in dotted lines in FIG. 9, has spaced side portions 74 extending perpendicularly to mirror housing 16. Side portions 74 are provided with a second aperture 76 which registers with first aperture 72 in the annular flange 64. Side portions 74 are spaced apart to slidingly receive annular flange 64. Fastener 78 comprises a shoulder bolt 80 and a nut 82 which releasably fastens annular flange 64 to U-shaped bracket 66. Shoulder bolt 80 is shaped to fit through second aperture 76 in side portions 74 of U-shaped bracket 66 and first aperture 72 in the annular flange 64, and is threaded to receive nut 82.

The second joint mechanism 84 extends from shaft 52 for rotatably connecting shaft 52 to windshield 14. Second joint mechanism 84 includes a ball-and-socket joint 86, which comprises a socket portion 88 and a ball 90 disposed in a conventional spherical bearing contact relationship to socket portion 88. Ball 90 is shaped to fit within an opening 92 in socket portion 88. Socket portion 88 comprises a socket 94 attached to a base portion 96. Opening 92 in socket 94 is disposed at an eccentric angle y to mount axis C-C. Opening 92 is disposed at an upward angle relative to axis C-C so as to compensate for windshield 14 being inclined at a downward angle to the horizontal. The socket 94 has an inner surface 98 which contacts an outer surface 100 of ball 90 so as to maintain the bearing contact relationship of ball 90 and socket 94. Socket 94 also includes a releasable securing means in the form of a second threaded aperture 102 into which a second set screw 104 may be releasably tightened to maintain the ball 90 and socket 94 in a stable bearing contact relationship. The ball 90 and the socket 94 can be formed of any suitable material, as for example, cast aluminum or steel formed by suitable molding techniques.

Mounts 42 include a pocket portion 106 shaped to receive base portion 96. Base portion 96 includes a frusto-conical shaped support stem 108 and a flat base plate 110 which connects to the bottom of socket 94. Pocket portion 106 comprises a front pocket 112 shaped for slidingly receiving base plate 110 and a flat back surface 114 for adhesively coupling pocket portion 106 to the windshield 14. Base plate 110 includes securing means for releasably securing base plate 110 to pocket portion 106, in the form of a third set screw 120 which fits into third threaded aperture 116 and notch 118 in pocket portion 106.

In use, the subject mirror apparatus is adhesively mounted to the windshield of the vehicle using a pair of pockets which are releasably secured to the base portion of the mounts using a set screw. Prior to operation of the vehicle, the driver adjusts the rear view mirror about a vertical and horizontal axis, using the first and second joint mechanisms, to obtain a suitable view towards the rear of the vehicle. The joint mechanisms are then rigidly secured using the set screws to prevent movement of the mirror apparatus during the operation of the vehicle. The adjustable mounts of the present invention are capable of solidly mounting the mirror apparatus to the windshields of most commercially available vehicles. They also provide a wide range of adjustments which enable the subject mirror apparatus to suit a wide range of drivers.

While what has been shown and described herein constitutes a preferred embodiment of the subject invention, it should be understood that various modifications and adaptions of such embodiment can be made without departing from the present invention, the scope of which is defined in the appended claims.

1. Rearview mirror apparatus for mounting to an inside portion of a front windshield of a vehicle, comprising:
(a) an elongated mirror housing shaped to extend along a longitudinal axis substantially across a top portion of the windshield, the housing having a elongated front opening;
(b) a planar mirror mounted within the opening of the housing, wherein the mirror is disposed in a plane extending at an angle to the longitudinal axis of the housing; and
(c) a pair of spaced mounts extending from a back portion of the housing for mounting the housing to the windshield.

2. The apparatus defined in claim 1, wherein the housing comprises a back wall extending in a first plane parallel to the longitudinal axis, an integral top portion, and an integral bottom portion, wherein the top portion and the bottom portion have front edges which together define a front surface extending in a second plane offset at an angle to the first plane, wherein the front surface defines an opening shaped for receiving the mirror.

3. The apparatus defined in claim 2, wherein the front opening and the planar mirror are generally rectangular in shape.

4. The apparatus defined in claim 2, wherein the front surface has a lip portion shaped for retaining the mirror within the housing.

5. The apparatus defined in claim 1, wherein the housing is shaped generally in the form of a wedge having a thin edge and a thick edge, wherein the thin edge of the wedge is positioned adjacent to the driver's side of the vehicle.

6. Rearview mirror apparatus for mounting to an inside portion of a front windshield of a vehicle, comprising:
(a) an elongated mirror housing extending along a longitudinal axis substantially across a top portion of the windshield of the vehicle;
(b) a planar mirror mounted within the housing; and
(c) a pair of spaced mounts extending from a back portion of the housing for mounting the housing to the windshield;
(d) wherein each of the mounts comprises an adjustable mount having a telescopic main body extending generally perpendicularly to the housing and the windshield.

7. The apparatus defined in claim 6, wherein the telescopic main body comprises a cylinder having a closed end adjacent to the housing and an open end adjacent to the windshield, a shaft shaped to slidingly fit within the cylinder through the open end, and securing means for adjustably securing the shaft in a set position relative to the cylinder.

8. The apparatus defined in claim 7, wherein each of the adjustable mounts also comprises a first joint mechanism extending from the closed end of the cylinder for pivotally connecting the cylinder to the housing, wherein the first joint mechanism is operable to pivot the housing about a pivot axis parallel to and spaced from the longitudinal axis of the housing.

9. The apparatus defined in claim 8, wherein each of the adjustable mounts also comprises a second joint mechanism extending from the shaft for rotatably connecting the shaft to the windshield.

10. An adjustable mount for mounting a housing for a rearview mirror to an inside portion of a windshield of a vehicle, comprising:
(a) a telescopic main body extending generally perpendicularly to the housing and the windshield, the telescopic main body comprising a cylinder having a closed end adjacent to the housing and an open end adjacent to the windshield, a shaft shaped to slidingly fit within the cylinder through the open end, and securing means for adjustably securing the shape in a set position relative to the cylinder;
(b) first joint mechanism extending from the closed end of the cylinder for pivotally connecting the cylinder to the housing; and
(c) a second joint mechanism extending from the shaft for rotatably connecting the shaft to the windshield.

11. The apparatus defined in claim 10, wherein the securing means comprises a keyed surface on the shaft, and a set screw within a threaded aperture in the side of the cylinder, the set screw being releasably tightenable against the shaft.

12. The apparatus defined in claim 10, wherein the first joint mechanism comprises an annular flange extending from the first end of the cylinder, and a U-shaped bracket attached to the mirror housing, the U-shaped bracket having spaced side portions extending perpendicularly to the housing, the side portions being spaced apart to slidingly receive the annular flange.

13. The apparatus defined in claim 12, wherein the annular flange has a central aperture, and the side portions of the U-shaped bracket have an aperture which registers with the aperture in the annular flange.

14. The apparatus defined in claim 13, wherein the first joint mechanism further comprises a fastener for releasably fastening the annular flange to the U-shaped bracket, wherein the fastener is shaped to fit through the apertures in the side portions of the U-shaped bracket and the aperture in the annular flange.

15. The apparatus as defined in claim 14, wherein the annular flange has flat opposed side surfaces, and wherein the side surfaces are serrated.

16. The apparatus defined in claim 15, wherein the second joint mechanism comprises a ball extending from the end of the shaft, and a socket portion attachable to the windshield, wherein the ball is shaped to fit within an opening in the socket portion.

17. The apparatus defined in claim 16, wherein the socket portion comprises a socket attached to a base, wherein the base includes a flat base plate.

18. The apparatus defined in claim 17, wherein the socket is mounted to the base at a preselected eccentric angle relative to the flat base plate.

19. The apparatus defined in claim 18, wherein each of the mounts further comprises a pocket portion having a flat back surface for adhesively coupling the mounts to the windshield, and a front pocket shaped for slidingly receiving the base plate.

20. The apparatus defined in claim 6, further comprising securing means for releasably securing the adjustable mounts in a set position, wherein the securing means comprises a set screw shaped to fit into a threaded aperture.
